(19) United States
(12) Patent Application Publication
(10) Pub. No.: US 2019/0179263 A1
(43) Pub. Date: Jun. 13, 2019

(54) APPARATUS FOR DISPLAYING HOLOGRAM

(71) Applicant: Electronics and Telecommunications Research Institute, Daejeon (KR)

(72) Inventors: Yongjun LIM, Sejong-si (KR); Hayan KIM, Daejeon (KR); Keehoon HONG, Daejeon (KR)

(73) Assignee: Electronics and Telecommunications Research Institute, Daejeon (KR)

(21) Appl. No.: 16/216,518

(22) Filed: Dec. 11, 2018

(30) Foreign Application Priority Data
Dec. 11, 2017 (KR) 10-2017-0169708
Dec. 7, 2018 (KR) 10-2018-0157567

(51) Int. Cl. G03H 1/22; G03H 1/00; G03H 1/24

(52) U.S. Cl. CPC G03H 1/2205; G03H 2001/2231; G03H 1/24; G03H 2222/17; G03H 2223/18; G03H 2223/15; G03H 2223/23; G03H 2225/61; G03H 2225/12; G03H 2225/24; G03H 2225/52; G03H 2001/0088; G03H 2001/2271; G03H 2001/2207; G03H 1/0005

(57) ABSTRACT

According to the present invention, by providing a hologram displaying apparatus including a light source configured to output a plurality of lights of different wavelengths in a first direction, a generator configured to generate a plurality of color holograms of different wavelengths using the plurality of light, and output the plurality of color holograms in the first direction, a filter configured to filter an effective hologram which is an element of an effective band of the plurality of color holograms in the first direction, and a display configured to transmit the effective hologram in the first direction and display the effective hologram in space in the first direction, it is possible to effectively filter an effective band of a certain diffraction order of each color hologram forming a composing hologram.

### CROSS-REFERENCE TO RELATED APPLICATION

This application claims priority to and the benefit of Korean Patent Application Nos. 10-2017-0169708 and 10-2018-0157567 filed in the Korean Intellectual Property Office on Dec. 11, 2017 and Dec. 7, 2018, respectively, the entire contents of which are incorporated herein by reference.

### BACKGROUND OF THE INVENTION

### (a) Field of the Invention

The present invention relates to a technique for filtering light of a certain wavelength in a holographic display apparatus.

### (b) Description of the Related Art

Recently, a 3D image has been utilized in various industries due to the development of 3D display technology. Particularly, holograms that display objects as in real life are being actively researched, and contents are being produced using holograms in various fields such as simultaneous broadcasting, display, and performances.

The holography technique is one of displaying a hologram in space using the phenomenon of light interference. Among the holography techniques, digital holography is a technique used to simultaneously record amplitude information and phase information of light using a laser, which is a coherent light source.

Digital holography is based on these technical features, and it can be used for holographic display technology which displays a 3D image, holographic printing technology, large capacity hologram storage technology for storing holograms, and holographic measurement technology for holographic microscopy for 3D imaging.

This work was supported by ‘The Cross-Ministry Giga KOREA Project’ grant funded by the Korea government (MSIT) (GK17D0100, Development of Telecommunications Terminal with Digital Holographic Table-top Display).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for effectively filtering an effective band corresponding to each wavelength of a light source of a holographic display apparatus.

A hologram displaying apparatus according to an exemplary embodiment of the present invention includes: a light source configured to output a plurality of lights of different wavelengths in a first direction; a generator configured to generate a plurality of color holograms of different wavelengths using the plurality of lights, and output the plurality of color holograms in the first direction; a filter configured to filter an effective hologram which is an element of an effective band of the plurality of color holograms in the first direction; and a display configured to transmit the effective hologram in the first direction and display the effective hologram in space in the first direction.

The effective hologram includes first order diffractive element of each of the plurality of color holograms.

The filter includes a plurality of filter regions filtering a plurality of color holograms corresponding to each of the different wavelengths, respectively.

The filter is located on a first plane perpendicular to the first direction, and an area of each of the plurality of filter regions is set based on wavelengths corresponding to each of the plurality of filter regions.

The length of each of the plurality of filter regions in the first direction is set based on wavelengths corresponding to each of the plurality of filter regions.

The apparatus includes a first lens configured to transmit the plurality of color holograms to the filter in the first direction, wherein the filter is located on a first plane perpendicular to the first direction, and the area of each of the plurality of filter regions is set based on a focal length of the first lens.

The length of each of the plurality of filter regions in the first direction is set based on a refractive index of the first lens, magnification of the first lens, or a numerical aperture of the first lens.

The generator includes a spatial light modulator including a plurality of pixels, the filter is located on a first plane perpendicular to the first direction, and an area of each of the plurality of filter regions is set based on a pixel pitch of the plurality of pixels.

The plurality of filter regions include: a first filter region configured to filter a first color hologram corresponding to a first wavelength; a second filter region configured to filter a second color hologram corresponding to a second wavelength greater than the first wavelength, and which surrounds the first filter region; and a third filter region configured to filter a third color hologram corresponding to a third wavelength greater than the second wavelength, and which surrounds the first filter region and the second filter region.

The first filter region filters the first color hologram, the second color hologram, and the third color hologram, the second filter region filters the second color hologram and the third color hologram, and the third filter region filters the third color hologram.

A hologram displaying method according to an exemplary embodiment of the present invention includes: outputting a plurality of lights of different wavelengths; generating a plurality of color holograms of different wavelengths using the plurality of lights; filtering an effective hologram which is an effective band element of the plurality of color holograms; and displaying the effective hologram.

The filtering includes filtering the effective band including a first order diffractive element in the entire spatial band of the plurality of color holograms.

The filtering includes filtering each of a plurality of color holograms corresponding to each of the different wavelengths.

A hologram displaying apparatus according to an exemplary embodiment of the present invention includes: a generator configured to generate a plurality of color holograms of different wavelengths using a plurality of lights of different wavelengths; a filter configured to filter an effective hologram including a first order diffractive element in the entire spatial band of the plurality of color holograms; and a display configured to display the effective hologram in space.

The filter includes a plurality of filter regions filtering each of a plurality of color holograms corresponding to each of the different wavelengths.

The filter is located on a first plane perpendicular to a first direction for obtaining the plurality of color holograms, and an area of each of the plurality of filter regions is set based on wavelengths corresponding to each of the plurality of filter regions.

The length in the first direction of each of the plurality of filter regions is set based on wavelengths corresponding to each of the plurality of filter regions.

The filter is located on a first plane perpendicular to a first direction for obtaining the plurality of color holograms, and further includes a first lens configured to transmit the plurality of color holograms to the filter in the first direction, and an area of each of the plurality of filter regions is set based on a focal length of the first lens.

The length of the plurality of filter regions in the first direction is set based on a refractive index of the first lens, magnification of the first lens, or a numerical aperture of the first lens.

The generator includes a spatial light modulator including a plurality of pixels, the filter is located on a first plane perpendicular to a first direction for obtaining the plurality of color holograms, and an area of each the plurality of filter regions is set based on a pixel pitch of the plurality of pixels.

### BRIEF DESCRIPTION OF THE DRAWINGS

FIG. 1 shows a graph showing diffraction angles of light according to an exemplary embodiment of the present invention.

FIG. 2 shows a hologram display apparatus displaying an effective hologram according to an exemplary embodiment of the present invention.

FIG. 3 shows a hologram display apparatus that produces a composing hologram according to an exemplary embodiment of the present invention.

FIG. 4 shows a hologram display apparatus for filtering a composing hologram according to an exemplary embodiment of the present invention.

FIG. 5 shows all the diffractive elements of the composing hologram according to an exemplary embodiment of the present invention.

FIG. 6 shows the relationship between a plurality of planes according to an exemplary embodiment of the present invention.

FIG. 7 shows a cross-sectional view on the x₃-y₃ plane of a single bandpass filter according to an exemplary embodiment of the present invention.

FIG. 8 shows a cross-sectional view on the x₃-y₃ plane of the filter containing an opening according to an exemplary embodiment of the present invention.

FIG. 9 shows a cross-sectional view on the x₃-y₃ plane showing an example of a filter according to an exemplary embodiment of the present invention.

FIG. 10 shows a cross-sectional view on the z-y₃ plane showing the depth element of the filter region according to an exemplary embodiment of the present invention.

FIG. 11 shows a cross-sectional view showing another example of a filter according to an exemplary embodiment of the present invention on the x3-y3 plane.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

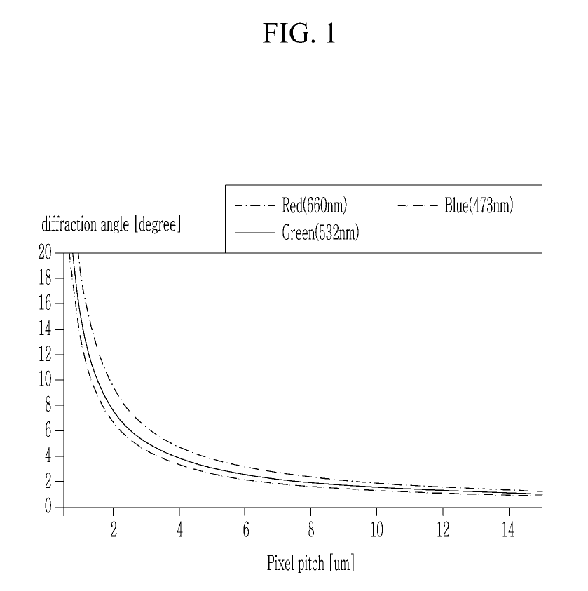

FIG. 1 shows a graph showing diffraction angles of light according to an exemplary embodiment of the present invention.

To display a hologram containing digital data, a spatial light modulator (SLM) apparatus capable of modulating the amplitude information or phase information of the light is required. In order to commercially utilize various digital holography applications, it is important to control the size of the displayed effective hologram (hologram image) and the range of areas in which the effective hologram can be viewed. In order to realize an ideal digital holographic display with a large effective hologram and a large viewing area, the size of each pixel element constituting the spatial light modulator must be small and the entire size of the spatial light modulator must be large.

That is, the viewing angle, which is the viewable area of the effective hologram, is controlled according to the pixel pitch of the spatial light modulator. Also, a size of the effective hologram is controlled by the overall panel size of the spatial light modulator.

A term “space bandwidth product (SBP)” is used as an index to simultaneously express the size information of the effective hologram and the viewing angle information to observe the effective hologram.

Expanding each pixel pitch of the spatial light modulator increases the size of the entire effective hologram, but reduces the viewing angle to see the effective hologram. Conversely, by reducing each pixel pitch of the spatial light modulator, the viewing angle for viewing the effective hologram is widened, but the size of the entire effective hologram is reduced.

Thus, the size and the viewing angle of the effective hologram in a holographic display have a trade-off relationship. That is, it is difficult to simultaneously improve both the size and the viewing angle of the effective hologram.

In general, pixel pitch (or pixel size or interval between pixels) of the pixel element of the spatial light modulator has a predetermined value. When a light source with a certain wavelength outputs light toward the elements of the spatial light modulator, the light is diffracted based on the pixel pitch of the spatial light modulator and passes through the spatial light modulator.

A diffraction angle of the light by the spatial light modulator can be calculated using Equation 1 below.

$$θ = {sin}^{- 1} ( \frac{λ}{2 * p} ) \qquad [ Equation 1 ]$$

Herein, λ is the wavelength of light incident on the spatial light modulator, and p is the pixel pitch of the spatial light modulator. As shown in Equation 1, the diffraction angle of light is determined by the wavelength of the light that illuminates the spatial light modulator and the pixel pitch between the pixels of the spatial light modulator. As shown in Equation 1 and FIG. 1, the diffraction angle is inversely proportional to the pixel pitch of the spatial light modulator and is proportional to the wavelength of the light.

As shown in the FIG. 1 and Equation 1, when a color hologram is generated by diffracting light through a spatial light modulator with the same pixel pitch and a composing hologram is generated by composing a plurality of color holograms, each color hologram corresponding to a different wavelength of light (e.g., red light, green light, and blue light) forms a different viewing angle. For example, by enlarging laser light (red light: 660 nm, green light: 532 nm, blue light: 473 nm) having different wavelengths to collimated light, focusing to the spatial light modulator having the same pixel pitch, focusing diffracted light passing through the spatial light modulator using a lens with a certain focal length f, and measuring the distance between the direct current (DC) element and the diffracted light in the lens plane of the lens, it is possible to observe the above phenomenon.

In the holographic display apparatus, only a first order element among the diffracted light from the spatial light modulator is used as the effective hologram. That is, in the holographic display apparatus, only the first order element is used as the effective hologram from a 0-th order diffracted light to an N-th order diffracted light, and the remaining diffracted light not used is spatially filtered.

Accordingly, a hologram display apparatus according to an exemplary embodiment of the present invention filters only certain orders (e.g., first order) of light (or effective bands). Also, according to an exemplary embodiment of the present invention, when a spatial light modulator having the same pixel pitch is used to generate an effective hologram, the hologram display apparatus simultaneously filters different bandwidths according to different wavelengths.

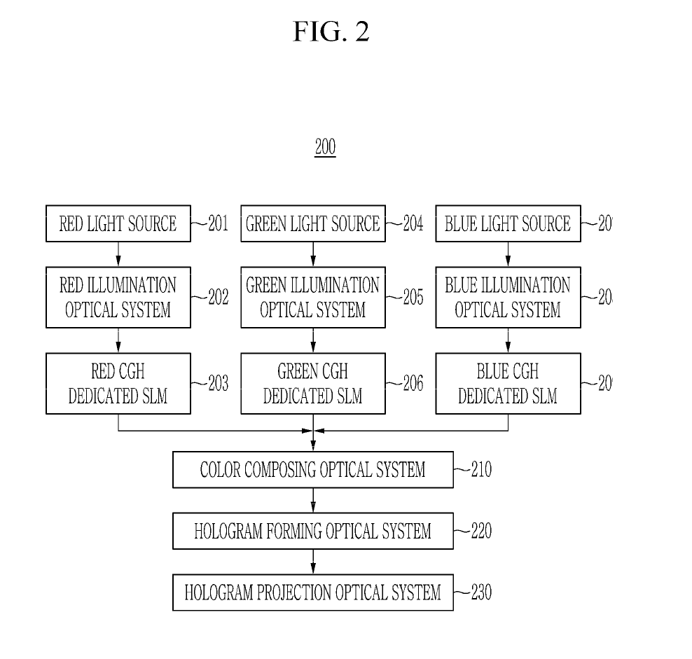

FIG. 2 shows a hologram display apparatus displaying an effective hologram according to an exemplary embodiment of the present invention.

As shown in FIG. 2, according to an exemplary embodiment of the present invention, a hologram display apparatus 200 includes a red light source 201, a green light source 204, a blue light source 207, a red illumination optical system 202, a green illumination optical system 205, a red CGH dedicated SLM 203, a green CGH dedicated SLM 206, a blue CGH dedicated SLM 209, a color composing optical system 210, a hologram forming optical system 220, and a hologram projection optical system 230.

The red light source 201 outputs red light. The red light source 201 transmits the output red light to the red illumination optical system 202. The red illumination optical system 202 obtains the red light from the red light source 201 and transmits the obtained red light to the red CGH dedicated SLM 203. Also, the red illumination optical system 202 transmits a red hologram from the SLM 203 dedicated to red CGH to the color composing optical system 210. The red CGH dedicated SLM 203 generates a red hologram using red light and a binary hologram, and transmits the red hologram to a color composing optical system 210.

The green light source 204 outputs green light. The green light source 204 transmits the output green light to the green illumination optical system 205. The green illumination optical system 205 obtains green light from the green light source 204 and transmits the obtained green light to the green CGH dedicated SLM 206. Also, the green illumination optical system 205 transfers the green hologram from the SLM 206 dedicated to the green CGH to the color composing optical system 210. The green CGH dedicated SLM 205 generates a green hologram using green light and a binary hologram, and transmits the green hologram to a color composing optical system 210.

The blue light source 207 outputs blue light. The blue light source 207 transmits the output blue light to the blue illumination optical system 208. The blue illumination optical system 208 acquires the blue light from the blue light source 207 and transmits the obtained blue light to the blue CGH dedicated SLM 209. The blue illumination optical system 208 also transmits the blue hologram from the SLM 209 dedicated to blue CGH to the color composing optical system 210. The blue CGH dedicated SLM 209 generates a blue hologram using blue light and a binary hologram, and transmits the blue hologram to a color composing optical system 210.

The red light source 201, a green light source 204, and the blue light source 207 output coherent light, respectively. The red illumination optical system 202, green illumination optical system 205, and blue illumination optical system 208 can be a lens. The red CGH dedicated SLM 203, green CGH dedicated SLM 206, and blue CGH dedicated SLM 209 may include a red DMD, a green DMD, and a blue DMD elements, respectively. On the other hand, a micro-display liquid crystal implemented on a silicon substrate similar to an LCD panel based on a liquid crystal is mainly used as the spatial light modulator. The elements of the spatial light modulator are mainly digital micro-mirror apparatuses (DMD) based on microelectromechanical system (MEMS) technology.

The color composing optical system 210 composes a composing hologram by composing the red hologram transmitted from the red CGH dedicated SLM 203, green hologram transmitted from the green CGH dedicated SLM 206, and blue hologram transmitted from the blue CGH dedicated SLM 209. The color composing optical system 210 transmits the composing hologram to the hologram forming optical system 220.

The hologram forming optical system 220 removes noise outside the effective band in the transmitted composing hologram to form an effective hologram. The hologram forming optical system 220 transmits the formed effective hologram to the hologram projection optical system 230.

The hologram projection optical system 230 may magnify the transmitted effective hologram using the lens and projects it onto the lens plane of the lens. On the lens plane, light of different wavelengths contained in the effective hologram appears in different regions.

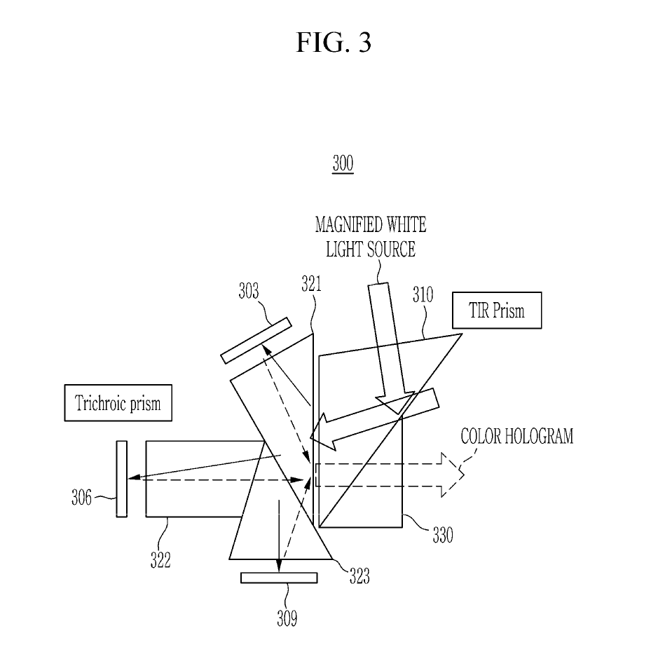

FIG. 3 shows a hologram display apparatus that produces a composing hologram according to an exemplary embodiment of the present invention.

As shown in FIG. 3, according to an exemplary embodiment of the present invention, a hologram display apparatus 300 includes a plurality of illumination optical systems 310, 321, 322, and 323, a plurality of SLMs 303, 306, and 309, and a color composing optical system 330.

The white light optical system 310 separates the enlarged white light into red light, green light, and blue light through a TIR prism. The red illumination optical system 321 transmits the red light to the red CGH dedicated SLM 303. The green illumination optical system 322 transmits green light to the green CGH dedicated SLM 306. The blue illumination optical system 323 transmits blue light to the SLM 309 dedicated to blue CGH.

Each SLM 303, 306, and 309 may include a trichroic prism. The SLMs 303, 306, and 309 generate a red hologram, a green hologram, and a blue hologram using red, green, and blue lights and binarized holograms, respectively. The SLMs 303, 306, and 309 transmit the red hologram, green hologram, and blue hologram to the color composing optical system 330.

The color composing optical system 330 may compose a red hologram, a green hologram, and a blue hologram to create a composing hologram including the red hologram, the green hologram, and the blue hologram. The color composing optical system 330 outputs the composing hologram.

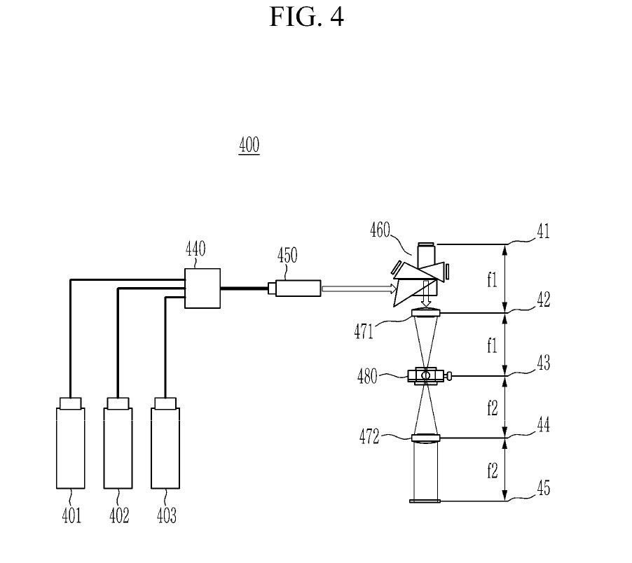

In order to remove noise from the output composing hologram to separate the effective hologram, the hologram forming optical system 220 of FIG. 2 is required, and in order to project the effective hologram, the hologram projection optical system 230 of FIG. 2 is required. The hologram forming optical system 220 of FIG. 2 and the hologram projection optical system 230 of FIG. 2 will be described below referring to FIG. 4.

FIG. 4 shows a hologram display apparatus for filtering a composing hologram according to an exemplary embodiment of the present invention.

As shown in FIG. 4, according to an exemplary embodiment of the present invention, a hologram display apparatus 400 includes a plurality of light sources 401, 402, and 403, a light composing unit 440, an optical output unit 450, and a 4f optical system 41, 42, 45, 460, 471, 472, 480.

The red light source 401, the green light source 402, and the blue light source 403 may output red light, green light, and blue light, respectively, and transmit them to the light composing unit 440 through optical fibers. The light composing unit 440 composes the transmitted red light, green light, and blue light into one white light, and transmits the white light to the optical output unit 450. The optical output unit 450 enlarges the white light and transmits the enlarged white light to the 4f optical system.

The 4f optical system includes the hologram forming optical system 220 and the hologram projection optical system 230 of FIG. 2. The 4f optical system includes a composing hologram generator 460, a first lens 471, a filter 480, and a second lens 472.

The 4f optical system includes an SLM plane 41, a first lens plane 42, a filter plane 43, a second lens plane 44, and a hologram plane 45. The distance between the SLM plane 41 and the first lens plane 42 and the distance between the filter plane 43 and the second lens plane 44 are equal to the focal length f1 of the first lens. The distance between the filter plane 43 and the second lens plane 44 and the distance between the second lens plane 44 and the hologram plane 45 are equal to the focal length f2 of the second lens.

The composing hologram generator 460 is located in the SLM plane 41. The composing hologram generator 460 includes a plurality of illumination optical systems 202, 205, and 208 and a plurality of SLMs 203, 206, and 209, and a color composing optical system 210 shown in FIG. 2. The composing hologram generator 460 includes a plurality of illumination optical systems 310, 321, 322, and 323, a plurality of SLMs 303, 306, and 309, and a color composing optical system 330 shown in FIG. 3. The composing hologram generator 460 generates a composing hologram and transfers the generated composing hologram to the first lens 471.

The first lens 471 is located in the first lens plane 42. The first lens 471 is spaced apart from the composing hologram generator 460 by f1. More specifically, the first lens 471 is spaced from the plurality SLMs 303, 306, and 309 by an optical distance f1. The first lens 471 refracts the transmitted composing hologram. The first lens 471 focuses the composing hologram on the first focal point spaced by the first focal length f1. The first focus point is located in the filter plane 43.

The filter 480 is located in the filter plane 43. The filter 480 is spaced from the first lens 471 by the focal length f1. The filter 480 is positioned on the focus point of the first lens 471. The focused composing hologram includes DC elements, ± first order, ± second order, and ± n-th order diffracted light in the entire spatial band. The filter 480 blocks the DC element, the ± second order elements, and the ±n-th ordered diffracted light of the composing hologram, and passes the first order diffracted light which is an element of the effective band. The + first order diffracted light and the − first order diffracted light can be defined as an effective hologram. The spatial band where the ± first order diffractive light passed through is defined as the effective band. The filter 480 enlarges and outputs the ± first order diffracted light. The filter 480 may be a single sideband filter.

The second lens 472 is located in the second lens plane 44. The second lens 472 is spaced from the filter 480 by the focal length f2 of the second lens. The second lens 472 may collimate the transmitted first order effective hologram to generate an effective hologram in the form of parallel light. The second lens 472 outputs the effective hologram in the form of parallel light. The effective hologram is displayed on the hologram plane 45.

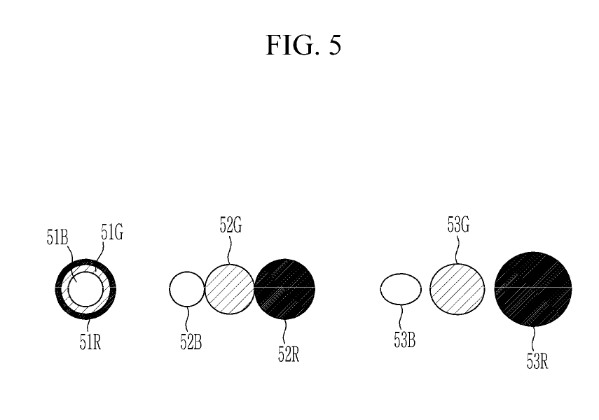

FIG. 5 shows all the diffractive elements of the composing hologram according to an exemplary embodiment of the present invention.

The composing hologram refracted by the first lens 471 of FIG. 4 may form a white circle at the center (e.g., the first focus point), and may form the first order, second order, and n-th order diffractive elements around the white circle. The white circle formed at the center is the DC element of the composing hologram.

As shown in FIG. 5, the red, blue, and green spots are diffracted at different angles according to the difference of each pixel pitch and each of the wavelengths of light of each color, and separated into different regions on the filter plane. 0-th order diffraction elements 51R, 51G, and 51B, which are DC elements, are formed at the center. First order diffractive elements 52R, 52G, and 52B are formed around the 0-th diffractive element. Secondary diffractive elements 53R, 53G, and 53B are formed at positions farther from the 0-th order diffractive element than the first order diffractive elements 52R, 52G, and 52B.

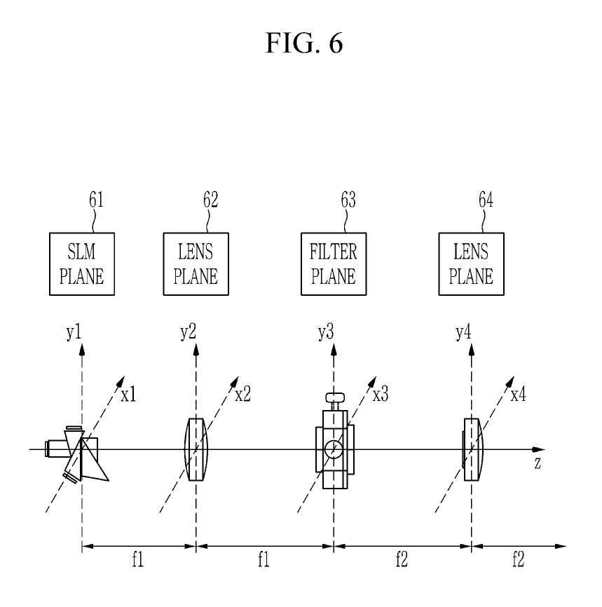

FIG. 6 shows the relationship between a plurality of planes according to an exemplary embodiment of the present invention.

As shown in FIG. 6, the SLM plane 61 is composed of the x₁ axis and the y₁ axis, and is located at one point on the z axis. The first lens plane 62 consists of the x₂ axis and the y₂ axis, and is located at another point on the z axis. The filter plane 63 consists of the x₃ axis and the y₃ axis, and is located at another point on the z axis. The second lens plane 64 consists of the x₄ axis and the y₄ axis, and is located at another point on the z axis.

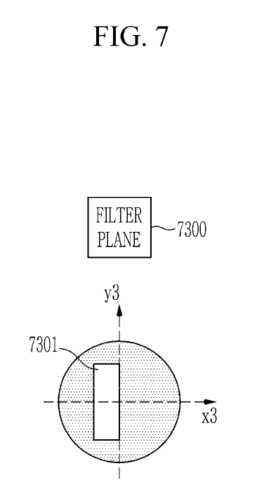

FIG. 7 shows a cross-sectional view on the x₃-y₃ plane of a single bandpass filter according to an exemplary embodiment of the present invention.

As shown in FIG. 7, the filter is located on the filter plane 7300. The filter is a single band pass filter that passes only the elements of the effective band reaching the aperture 7301 of the band in the adjacent two quadrants among the elements of the composing hologram passing through the entire x₃-y₃ plane, and blocks all elements transmitted to the other areas. The filter may form the filtered effective hologram on the hologram plane spaced away from the filter plane 7300 by 212.

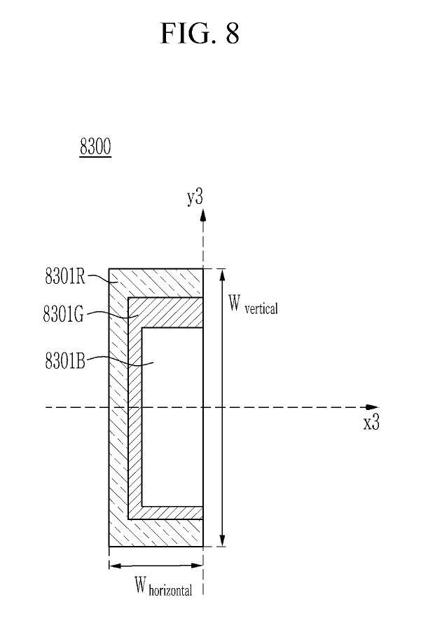

FIG. 8 shows a cross-sectional view on the x₃-y₃ plane of the filter containing an opening according to an exemplary embodiment of the present invention.

On the other hand, if pixel pitches of the pixel elements of all the SLMs are the same and the wavelengths of the incident light diffracted through each SLM is different, the size of the bandpass filter for passing the hologram of each color corresponding to each wavelength must be different.

As shown in FIG. 8, filters (8301R, 8301G, and 8301B) of which sizes are determined based on Equation 2 and Equation 3 are located on the filter plane 8300. The filter includes a blue filter region 8301B, a green filter region 8301G, and a red filter region 8301R. That is, based on Equation 2 and Equation 3, the blue filter region 8301B is smaller than both of the green filter region 8301G and the red filter region 8301R. Also, based on Equation 2 and Equation 3, the green filter region 8301G is smaller in both the vertical size and the horizontal size than the red filter region 8301R.

The blue filter region 8301B passes the red hologram, green hologram, and blue hologram in the effective band of the composing hologram. The green filter region 8301G passes the red hologram and green hologram in the effective band of the composing hologram. The red filter region 8301R passes the red hologram in the effective band of the composing hologram.

The blue filter area 8301B consists of an optically transparent material for red, green, and blue to pass the red hologram, the green hologram, and the blue hologram in the effective band of the composing hologram. The blue filter region 8301B may be opened to pass the red hologram, the green hologram, and the blue hologram.

The green filter region 8301G consists of an optically transparent material for red and green while blocking the blue to pass the red hologram and the green hologram in the effective band of the composing hologram.

The red filter region 8301R consists of an optically transparent material for red and blocks green and blue to pass the red hologram in the effective band of the composing hologram. Each of the filter regions 8301B, 8301G, and 8301R may be a dichroic filter passing a certain band.

All signals reaching the outside of the red filter region 8301R are blocked by the filter.

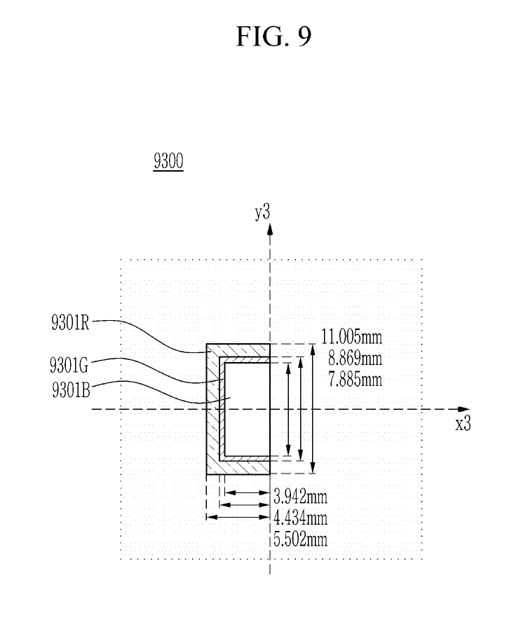

FIG. 9 shows a cross-sectional view on the x₃-y₃ plane showing an example of a filter according to an exemplary embodiment of the present invention.

A horizontal size of each filter region (aperture) according to the wavelengths of three primary colors (red, green, and blue) to be disposed in the filter plane 9300 may be calculated using Equation 2 below.

W_{horizontal}=f tan[sin⁻¹(λ/2p)] [Equation 2]

The hologram display apparatus may calculate the vertical size of the apertures according to the three primary color wavelengths for applying a single band filter using Equation 3 below.

W_{vertical}=2f tan[sin⁻¹(λ/2p)] [Equation 3]

In Equation 2 and Equation 3 described above, f is same as the first focal length f1 shown in FIG. 6. λ is the wavelength of the light incident on the spatial light modulator. p is the pixel pitch of the spatial light modulator.

The horizontal size (W_{horizontal}) and the vertical size (W_{vertical}) of the aperture of the filter calculated based on a predetermined pixel pitch (p=10.8 μm) of the SLM, the focal length (f1=180 mm) of the first lens, Equation 2 and Equation 3, and wavelengths (red is 660 nm, green is 532 nm and blue is 473 nm) of the light of different colors among elements of the composing hologram are shown in Table 1 below.

TABLE 1

| SLM pixel | Focal | | Wave- | Horizontal | Vertical |
|---|---|---|---|---|---|
| pitch | length | Light | length | size | size |
| (μm) | (mm) | source | (nm) | (mm) | (mm) |
| 10.8 | 180 | blue | 473 | 3.942 | 7.885 |
| | | green | 532 | 4.434 | 8.869 |
| | | red | 660 | 5.502 | 11.005 |

As shown in FIG. 9, the horizontal size of the red filter region 9301R calculated in the above Table 1 is 5.502 mm and the vertical size is 11.005 mm, the horizontal size of the green filter region 9301G is 4.434 mm and the vertical size is 8.869 mm, and the horizontal size of the blue filter region 9301B is 3.942 mm and the vertical size is 7.885 mm.

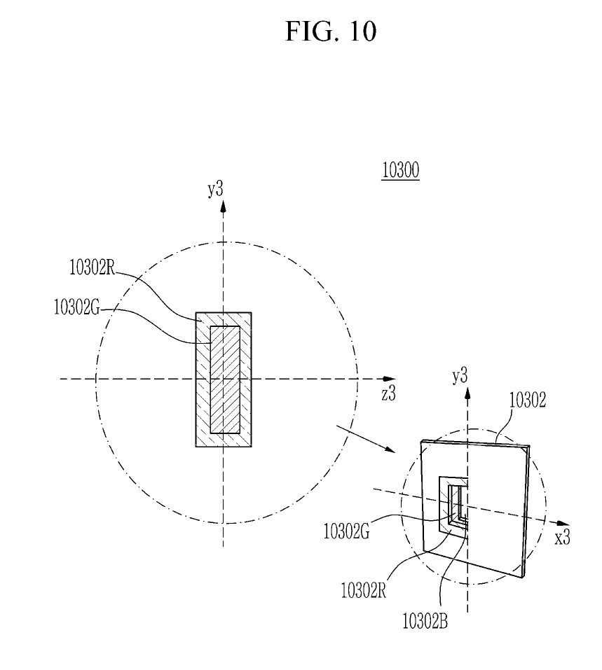

FIG. 10 shows a cross-sectional view on the z₃-y₃ plane showing the depth element of the filter region according to an exemplary embodiment of the present invention.

On the x₃-y₃ plane, the filter is formed as shown in FIG. 7 to FIG. 9. However, considering the direction of the z-axis which is the traveling direction of the light, the filter is located by determining a thickness of the filter in the positive direction and in the negative direction of the z-axis on the first lens plane.

On the other hand, depth of focus of the lens depends on a characteristic (for example, caliber) of the lens. In addition, the depth of focus of the lens depends on the wavelength of the light passing through the lens as well as the characteristic of the lens.

Therefore, it is necessary to determine not only the vertical size and the horizontal size of the filter region (aperture) according to each wavelength of the filter, but also the thickness of the aperture passing through different wavelengths for each filter region corresponding to each wavelength.

The thickness of each of the different filter regions according to the wavelength of each color is determined to be equal to the depth of focus according to each wavelength. The depth of focus is determined using Equation 4 below.

DOF=2*n*M²*λ/(N.A)² [Equation 4]

“DOF” is the abbreviation of depth of focus, and represents the length of the depth of focus. n is the refractive index of the lens. M is the magnification of the optical system. λ is the wavelength of each light. N.A means the numerical aperture of the lens.

As shown in Equation 4, the red filter region 10302R disposed in the filter plane 10300 is thicker than the green filter region 10302G. The green filter region 10302G is thicker than the blue filter region 10302B. That is, the thickness of the filter region decreases from the red filter region 10302R to the blue filter region 10302B.

The blue filter region (10302B) of the filter of the hologram display apparatus passes the red hologram, the green hologram, and the blue hologram through the blue filter region (10302B). The green filter region 10302G of the filter passes the red hologram and the green hologram passing through the green filter region 10302G and blocks the blue hologram. The red filter region 10302R of the filter passes only the red hologram passing through the red filter region 10302R, and blocks the green hologram and the blue hologram.

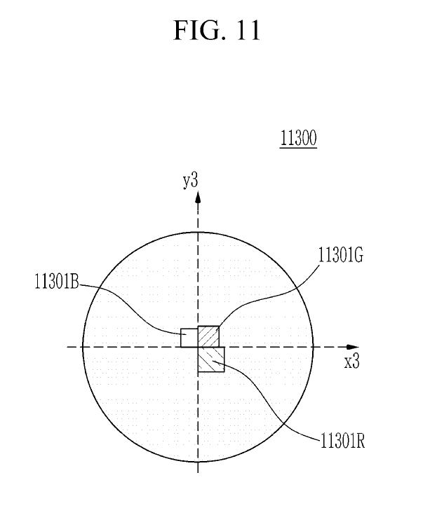

FIG. 11 shows a cross-sectional view showing another example of a filter according to an exemplary embodiment of the present invention on the x₃-y₃ plane.

As shown in FIG. 11, a red filter region 11301R, a green filter region 11301G, and a blue filter region 11301B on the filter plane 11300 may be disposed in different quadrants, unlike the shape as shown in FIG. 7 to FIG. 9.

For example, the red filter region 11301R may be located in the fourth quadrant among the first to fourth quadrants, the green filter region 11301G is located in the first quadrant, and the blue filter region 11301B is located in the second quadrant.

For example, the shapes of the respective filter regions 11301R, 11301G, and 11301B may be a square shape, unlike the shape as shown in FIG. 7 to FIG. 9.

The red filter region 11301R passes the red hologram reaching the red filter region 11301R located in the fourth quadrant among the elements of the composing hologram reaching the filter plane 11300, and blocks the remaining signals.

The green filter region 11301G passes the green hologram reaching the green filter region 11301G located in the first quadrant among the elements of the composing hologram reaching the filter plane 11300, and blocks the remaining signals.

The blue filter region 11301B passes through the blue hologram reaching the blue filter region 11301B located in the second quadrant among the elements of the composing hologram reaching the filter plane 11300, and blocks the remaining signals.

The blue hologram, the green hologram, and the red hologram, which pass through the respective filter regions 11301R, 11301G, and 11301B, reach the hologram plane to form an effective hologram image.

The hologram display apparatus may form each of the filter regions 11301R, 11301G, and 11301B based on the phase shifting technique in digital holography.

The thickness of the z-axis direction of each of the filter regions 11301R, 11301G, and 11301B may be determined differently based on the depth of focus described in reference with FIG. 9. For example, as described referring to FIG. 9, the thickness in the z-axis direction of the red filter region 11301R passing through the red hologram is greater than the thickness of the green filter region 11301G passing the green hologram of green light having a shorter wavelength than the red light. For example, referring to FIG. 9, the thickness in the z-axis direction of the green filter area 11301G passing through the green hologram is greater than the thickness in the z-axis direction of the blue filter area 11301B passing through the blue hologram of the blue light having the shorter wavelength than the green light.

The relative positions of the respective filter regions 11301R, 11301G, and 11301B may not be fixed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to an exemplary embodiment of the present invention, it is possible to effectively filter the effective band which is the band of a certain diffraction order of each color hologram forming the composing hologram by improving the single band filter method used to implement the binarization hologram.

According to an exemplary embodiment of the present invention, it is possible to improve the color matching performance in a digital holographic display apparatus by using an effective band filter capable of temporarily filtering an effective band.

According to an exemplary embodiment of the present invention, through the filtering technique in the digital holographic display apparatus, it is possible to improve the quality of the hologram image by removing noise from all wavelengths within the composing hologram.

According to an exemplary embodiment of the present invention, the distortion phenomenon of the hologram image can be objectively derived and evaluated by separating the distortion factor of the hologram image signal from the distortion factor by the aberration.

What is claimed is:

1. A hologram displaying apparatus, comprising:
a light source configured to output a plurality of lights of different wavelengths in a first direction;
a generator configured to generate a plurality of color holograms of different wavelengths using the plurality of lights, and output the plurality of color holograms in the first direction;
a filter configured to filter an effective hologram which is an element of an effective band of the plurality of color holograms in the first direction; and
a display configured to transmit the effective hologram in the first direction, and display the effective hologram in space in the first direction.

2. The apparatus of claim 1, wherein
the effective hologram includes first order diffractive element of each of the plurality of color holograms.

3. The apparatus of claim 1, wherein
the filter includes a plurality of filter regions filtering a plurality of color holograms corresponding to each of the different wavelengths, respectively.

4. The apparatus of claim 3, wherein
the filter is located on a first plane perpendicular to the first direction, and
an area of each of the plurality of filter regions is set based on wavelengths corresponding to each of the plurality of filter regions.

5. The apparatus of claim 3, wherein
a length of each of the plurality of filter regions in the first direction is set based on wavelengths corresponding to each of the plurality of filter regions.

6. The apparatus of claim 3, further comprising
a first lens configured to transmit the plurality of color holograms to the filter in the first direction,
wherein the filter is located on a first plane perpendicular to the first direction, and
an area of each of the plurality of filter regions is set based on a focal length of the first lens.

7. The apparatus of claim 6, wherein
a length of each of the plurality of filter regions in the first direction is set based on a refractive index of the first lens, magnification of the first lens, or a numerical aperture of the first lens.

8. The apparatus of claim 3, wherein
the generator includes a spatial light modulator including a plurality of pixels,
the filter is located on a first plane perpendicular to the first direction, and
an area of each of the plurality of filter regions is set based on a pixel pitch of the plurality of pixels.

9. The apparatus of claim 3, wherein
the plurality of filter regions include:
a first filter region configured to filter a first color hologram corresponding to a first wavelength;
a second filter region configured to filter a second color hologram corresponding to a second wavelength greater than the first wavelength, and which surrounds the first filter region; and
a third filter region configured to filter a third color hologram corresponding to a third wavelength greater than the second wavelength, and which surrounds the first filter region and the second filter region.

10. The apparatus of claim 9, wherein
the first filter region filters the first color hologram, the second color hologram, and the third color hologram,
the second filter region filters the second color hologram and the third color hologram, and
the third filter region filters the third color hologram.

11. A method for filtering an effective band of a plurality of color holograms, comprising:
outputting a plurality of lights of different wavelengths;
generating a plurality of color holograms of different wavelengths using the plurality of lights;
filtering an effective hologram which is an effective band element of the plurality of color holograms; and
displaying the effective hologram.

12. The method of claim 11, wherein
the filtering includes
filtering the effective band including a first order diffractive element in the entire spatial band of the plurality of color holograms.

13. The method of claim 11, wherein
the filtering includes
filtering each of a plurality of color holograms corresponding to each of the different wavelengths.

14. A hologram displaying apparatus, comprising:
a generator configured to generate a plurality of color holograms of different wavelengths using a plurality of lights of different wavelengths;
a filter configured to filter an effective hologram including a first order diffractive element in the entire spatial band of the plurality of color holograms; and
a display configured to display the effective hologram in space.

15. The apparatus of claim 14, wherein
the filter includes a plurality of filter regions filtering each of a plurality of color holograms corresponding to each of the different wavelengths.

16. The apparatus of claim 15, wherein
the filter is located on a first plane perpendicular to a first direction for obtaining the plurality of color holograms, and
an area of each of the plurality of filter regions is set based on wavelengths corresponding to each of the plurality of filter regions.

17. The apparatus of claim 16, wherein
a length in the first direction of each of the plurality of filter regions is set based on wavelengths corresponding to each of the plurality of filter regions.

18. The apparatus of claim 15, wherein
the filter is located on a first plane perpendicular to a first direction for obtaining the plurality of color holograms, and
further comprising a first lens configured to transmit the plurality of color holograms to the filter in the first direction, and
an area of each of the plurality of filter regions is set based on a focal length of the first lens.

19. The apparatus of claim 18, wherein
a length of the plurality of filter regions in the first direction is set based on a refractive index of the first lens, magnification of the first lens, or a numerical aperture of the first lens.

20. The apparatus of claim 15, wherein
the generator includes a spatial light modulator including a plurality of pixels,
the filter is located on a first plane perpendicular to a first direction for obtaining the plurality of color holograms, and
an area of each the plurality of filter regions is set based on a pixel pitch of the plurality of pixels.
